(19) United States
(12) Patent Application Publication
(10) Pub. No.: US 2025/0207966 A1
(43) Pub. Date: Jun. 26, 2025

(54) METHODS AND SYSTEMS FOR DETERMINING A QUANTITY OF FUEL DISPENSED AT A FUELING STATION BASED ON AUDIO

(71) Applicant: Robert Bosch GmbH, Stuttgart (DE)

(72) Inventors: IBRAHIM ESHERA, Clarksville, MD (US); CHARLES SHELTON, Monroeville, PA (US); SAMARJIT DAS, Wexford, PA (US)

(21) Appl. No.: 18/389,979

(22) Filed: Dec. 20, 2023

(51) Int. Cl. G01F 22/00; B67D 7/08; G06V 20/52

(52) U.S. Cl. CPC G01F 22/00; B67D 7/08; G06V 20/52; G06V 2201/08

(57) ABSTRACT

Methods and system for determining a quantity of fuel dispensed at a fueling station based on audio, as well as training such a system. Audio data is generated from one or more microphones, wherein the audio data is associated with stages of a refueling operation at a fueling station. A machine learning model is executed on the audio data to segment the audio data into segments, with each segment associated with a respective one of the stages of the refueling operation. The model also determines that one of the segments is associated with a fuel flow stage indicating fuel is flowing from a fuel storage. This allows the system to determine a quantity of fuel being dispensed, based on the time of the one segment.

### TECHNICAL FIELD

The present disclosure relates to methods and systems for determining a quantity of fuel dispensed at a fueling station based on audio.

### BACKGROUND

Internet of Things (IoT) systems based on machine and deep-learning algorithms are becoming pervasive in both industrial and consumer applications. The commercial success of such systems is strongly related to meeting expectations for accuracy, precision, recall, and coverage. The development of highly accurate deep-learning systems is directly influenced by the availability of a large and varied collection of training and evaluation data. A wide variety of evaluation data is necessary to assess the performance of a system before it is manufactured and deployed. A large amount of labeled data is key to training complex and large deep-learning models capable of meeting the desired levels of performance.

### SUMMARY

According to an embodiment, method of determining a quantity of fuel dispensed at a fueling station based on audio is provided. The method includes generating audio data from one or more microphones, wherein the audio data is associated with stages of a refueling operation at a fueling station. The method includes executing a machine learning model on the audio data, wherein the machine learning model is configured to, upon execution: (1) segment the audio data into segments, wherein each segment is associated with a respective one of the stages of the refueling operation; (2) determine that a first segment of the segments includes audio associated with a fuel flow stage of the refueling operation in which fuel is dispensed; (3) determine a length of time of the first segment; and (4) determine a quantity of fuel dispensed based on the length of time of the first segment.

Systems are also disclosed that include a microphone and a processor programmed to execute these steps.

In another embodiment, a system for training a machine learning model to determine a quantity of fuel dispensed at a fueling station based on audio includes a microphone and a processor and memory. The microphone is installed at a fueling station and is configured to generate audio data associated with stages of a refueling operation occurring at the fueling station. The memory has instructions that, when executed by the processor, cause the processor to: (1) receive annotations associated with the audio data from an annotator, wherein the annotations include a segmentation of the audio data with labels, wherein each label is associated with a respective stage of the refueling operation; (2) provide, as training data, the segmentations of the audio data and the labels to a machine learning model; (3) train the machine learning model to identify the stages of the refueling operation based on the training data; and (4) output a trained machine learning model configured to identify the stages of the refueling operation based on audio.

### BRIEF DESCRIPTION OF THE DRAWINGS

FIG. 1 generally illustrates a system for training a neural network according to an embodiment of the present disclosure.

FIG. 2 generally illustrates a computer-implemented method for training and utilizing a neural network according to an embodiment of the present disclosure.

FIG. 3A generally illustrates an audio data labeling system according to an embodiment of the present disclosure.

FIG. 3B generally illustrates a portion of a data capturing system according to the principles of the present disclosure.

FIG. 3C generally illustrates an alternative audio data labeling system, according to an embodiment of the present disclosure.

FIG. 4A-4E generally illustrate various stages of fueling operations that occur at a fueling station, along with audio capturing device installed, according to an embodiment.

FIG. 5A generally illustrates a block diagram showing an overall schematic of a system for determining stages of a refueling operation, according to an embodiment.

FIG. 5B generally illustrates a spectrogram with labeled audio segments according to an embodiment.

FIG. 6 generally illustrates a flow chart of a method of determining a quantity of fuel dispensed at a fueling station based utilizing an audio-based machine learning model, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The success of deep-learning solutions in real-world applications is highly related to the quality of data in performing the tasks they are designed for. When it comes to training and evaluating deep-learning systems, acquiring varied and large quantities of labeled data may be necessary to train the system effectively, and evaluate its performance under a variety of conditions.

At the same time, making sense of sounds is one of the growing topics in the Artificial Intelligence (AI) community. In several AI pipelines, specifically deep-learning-based ones, having access to large amount of labeled data is key to successfully tackling the task at hand. However, audio data collection and annotation are much more challenging compared to other domains such as vision, text etc.

Some shared-usage depots may benefit from AI. For example, airports and other similar places may operate fueling stations, which allow for large tanker trucks to load up with fuel (e.g., JET A-1 aviation fuel, aviation gasoline (Avgas), etc.), and yet not own the rights to the fueling equipment located at the airport. Therefore the airport may be unable to install a meter or gauge to measure the fuel exiting the fueling station by the various companies that use the shared-usage depot. Instead, they rely on rough estimates and an honor system which can lead to discrepancies in fueling amounts.

Therefore, according to various embodiments disclosed herein, methods and systems of training a ML model based on audio data to determine various refueling operations. In embodiments, to train the model, audio data is segmented and labeled according to the various refueling operations that take place, such as a fueling truck entering the fueling station, the truck being grounded or connected to the fuel lines, the refueling pump being initiated, fuel flowing into the truck, the truck being disconnected to the fuel lines, and the vehicle leaving the fueling station. Based on the audio data, the ML model is able to identify the moments in which fuel is flowing into the truck. Based on this identified moment, and the amount of time that passes, the model can determine how much fuel is being transferred into the tanker truck.

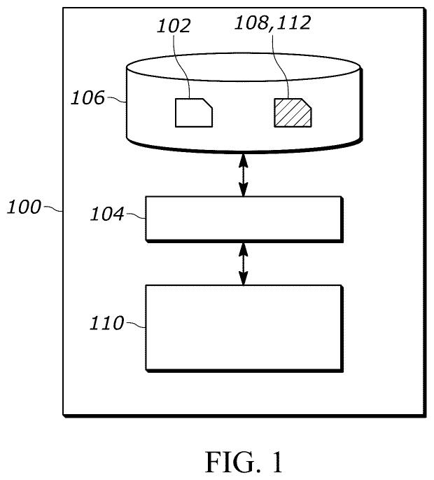

FIG. 1 shows a system 100 for training a neural network (e.g., of an ML model). The system 100 may be configured to (and/or include circuitry configured to) implement the systems and methods of the present disclosure described below in more detail. The system 100 may comprise an input interface for accessing training data 102 for the neural network. For example, as illustrated in FIG. 1, the input interface may be constituted by a data storage interface 104 which may access the training data 102 from data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also external data storage, e.g., network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

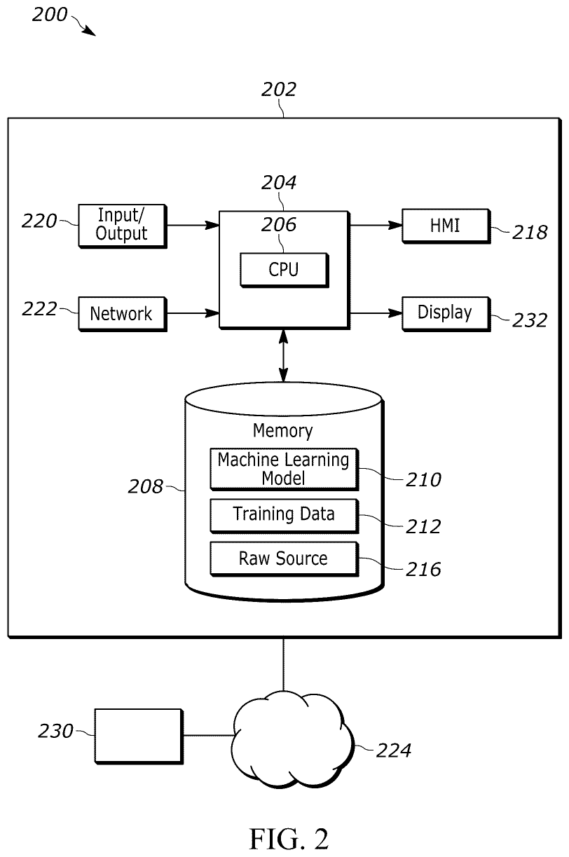

FIG. 2 depicts a data annotation/augmentation system 200 configured to (and/or including circuitry configured to) implement a system for annotating, labeling, and/or augmenting data. The data annotation system 200 may include at least one computing system 202 configured to implement all or portions of the systems and methods of the present disclosure explained below in more detail. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. Various components of the system 200 may be implemented with same or different circuitry.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 (e.g., represented in FIG. 2 as the ML Model 210) or algorithm, a training dataset 212 for the machine-learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning model 210 that is configured to analyze the raw source dataset 216. For example, the CPU 206 and/or other circuitry may implement the machine-learning model 210. The raw source dataset 216 may include raw or unprocessed sensor data that may be representative of an input dataset for a machine-learning system. The raw source dataset 216 may include video, video segments, images, audio, text-based information, and raw or partially processed sensor data (e.g., radar map of objects). In some embodiments, the machine-learning model 210 may be a deep-learning or neural network algorithm that is designed to perform a predetermined function. For example, the neural network algorithm may be configured to identify events or objects in video segments based on audio data.

The computer system 200 may store the training dataset 212 for the machine-learning model 210. The training dataset 212 may represent a set of previously constructed data for training the machine-learning model 210. For example, the training dataset 212 according to the present disclosure may include multiple automatically-collected ground-truth measurements and associated data. The training dataset 212 may be used by the machine-learning model 210 to learn weighting factors associated with a neural network algorithm. The training dataset 212 may include a set of source data that has corresponding outcomes or results that the machine-learning model 210 tries to duplicate via the learning process.

The machine-learning model 210 may be operated in a learning mode using the training dataset 212 as input. The machine-learning model 210 may be executed over a number of iterations using the data from the training dataset 212. With each iteration, the machine-learning model 210 may update internal weighting factors based on the achieved results. For example, the machine-learning model 210 can compare output results (e.g., annotations) with those included in the training dataset 212. Since the training dataset 212 includes the expected results, the machine-learning model 210 can determine when performance is acceptable. After the machine-learning model 210 achieves a predetermined performance level (e.g., 100% agreement with the outcomes associated with the training dataset 212), the machine-learning model 210 may be executed using data that is not in the training dataset 212. The trained machine-learning model 210 may be applied to new datasets to generate annotated data.

The machine-learning model 210 may be configured to identify a particular feature in the raw source data 216. The raw source data 216 may include a plurality of instances or input dataset for which annotation results are desired (e.g., a video stream or segment including audio data). For example only, the machine-learning model 210 may be configured to identify objects or events in a video segment based on audio data and annotate the events. The machine-learning model 210 may be programmed to process the raw source data 216 to identify the presence of the particular features. The machine-learning model 210 may be configured to identify a feature in the raw source data 216 as a predetermined feature. The raw source data 216 may be derived from a variety of sources. For example, the raw source data 216 may be actual input data collected by a machine-learning system. The raw source data 216 may be machine generated for testing the system. As an example, the raw source data 216 may include raw video and/or audio data from a camera, audio data from a microphone, etc.

In an example, the machine-learning model 210 may process raw source data 216 and output video and/or audio data including one or more indications of an identified event. The machine-learning model 210 may generate a confidence level or factor for each output generated. For example, a confidence value that exceeds a predetermined high-confidence threshold may indicate that the machine-learning model 210 is confident that the identified event (or feature) corresponds to the particular event. A confidence value that is less than a low-confidence threshold may indicate that the machine-learning model 210 has some uncertainty that the particular feature is present.

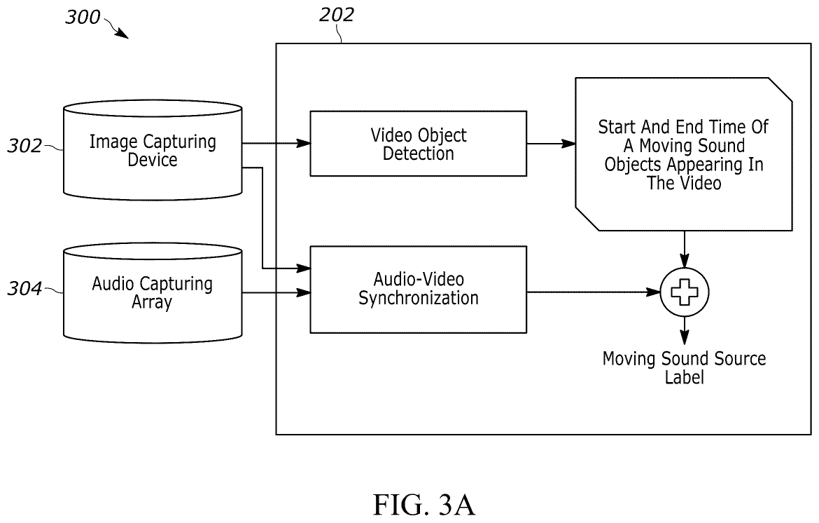

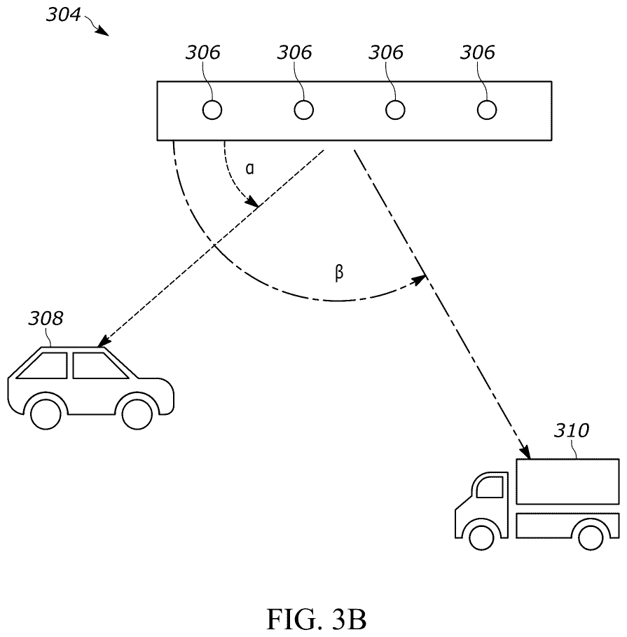

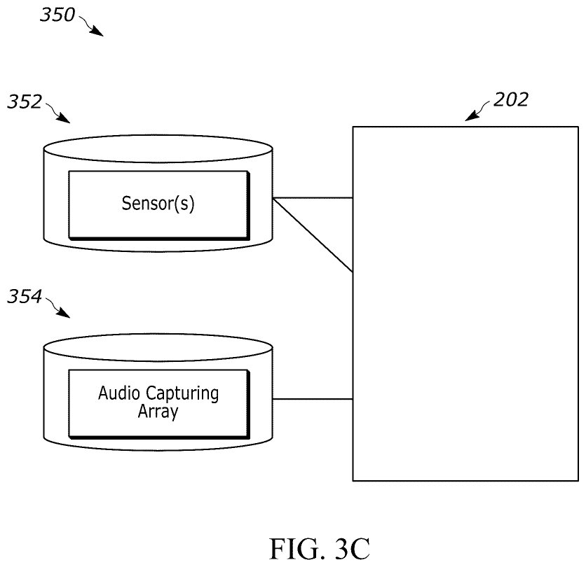

As is generally illustrated in FIGS. 3A and 3B, a system 300 may include an image (e.g., video) capturing device 302, an audio capturing array 304, and the computing system 202. The system may receive, from the image capturing device 302, video stream data associated with a data capture environment. The system 202 may be configured to perform video object detection to identify one or more objects (e.g., fuel truck) in corresponding images of the video stream data. The system 202 may receive, from the audio capturing array 304, audio stream data that corresponds to at least a portion of the video stream data. The audio capturing array 304 may include one or more microphones 306 or other suitable audio capturing devices. The systems and methods described herein may be configured to label, using output from at least a first machine-learning model (e.g., such as the machine-learning model 210 or other suitable machine-learning model configured to provide output including one or more object or event detection predictions), at least some objects of the video stream data and/or audio stream data.

The system 202 may calculate (e.g., using at least one probabilistic-based function or other suitable technique or function), based on at least one data capturing characteristic, at least one offset value for at least a portion of the audio stream data that corresponds to at least one labeled object of the video stream data. The system 202 may synchronize, using at least the at least one offset value, at least a portion of the video stream data with the portion of the audio stream data that corresponds to the at least one labeled object of the video stream data. The at least one data capturing characteristic may include one or more characteristics of the at least one image capturing device, one or more characteristics of the at least one audio capturing array, one or more characteristics corresponding to a location of the at least one image capturing device relative to the at least one audio capturing array, one or more characteristics corresponding to a movement of an object in the video stream data, one or more other suitable data capturing characteristics, or a combination thereof.

The system 202 may label, using one or more labels of the labeled objects of the video stream data and the at least one offset value, at least the portion of the audio stream data that corresponds to the at least one labeled object of the video stream data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model.

In some embodiments, as is generally illustrated in FIG. 3C, the computing system 202 may be configured to label audio data based on sensor data received from one or more sensors, such as those described herein or any other suitable sensor or combination of sensors. The system 202 may receive, from the audio capturing array 354 or any suitable audio capturing device, such as one or more of the microphones 306 or other suitable audio capturing device, audio stream data associated with a data capture environment. It should be understood that the audio capturing array 354 may include features similar to those of the audio capturing array 304 and may include any suitable number of audio capturing devices. The system 202 may receive, from at least one sensor (e.g., such as the sensor 352) that is asynchronous relative to the audio capturing array 354, sensor data associated with the data capture environment. The sensor 354 may include at least one of an induction coil, a radar sensor, a LiDAR sensor, a sonar sensor, an image capturing device, any other suitable sensor, or a combination thereof. The audio capturing array 354 may be remotely located from the sensor 354, proximately located to the sensor 354, or located in any suitable relationship to the sensor 354.

The system 202 may identify, using output from at least a first machine learning model, such as the machine learning model 210 or other suitable machine learning model, at least some events in the sensor data. The machine learning model 210 may be configured to provide output including one or more event detection predictions based on the sensor data. The system 202 may synchronize at least a portion of the sensor data associated with the portion of the audio stream data that corresponds to the at least one event of the sensor data. The system 202 may label, using one or more labels extracted for respective events of the sensor data value, at least the portion of the audio stream data that corresponds to the at least one event of the sensor data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function.

Any of the systems described above and/or below in more detail may be configured to implement automated collection of ground-truth data using multiple different sensors to train a machine or deep learning model according to the present disclosure. In one example, a microphone array is installed at or near a refueling depot or station where trucks or other vehicles travel to in order to refuel. A model is trained (e.g., by human labeling) so as to understand detected sounds that correspond to the different refueling operations. During training of the system, a synchronized camera for visual ground truth data generation can be installed as well, which allows visual confirmation of the audio events detected by the model. The data generated by the camera can be used in a video-based ML model to identify, visually, the refueling events and synchronize those with the audio data in order to label the audio events accordingly.

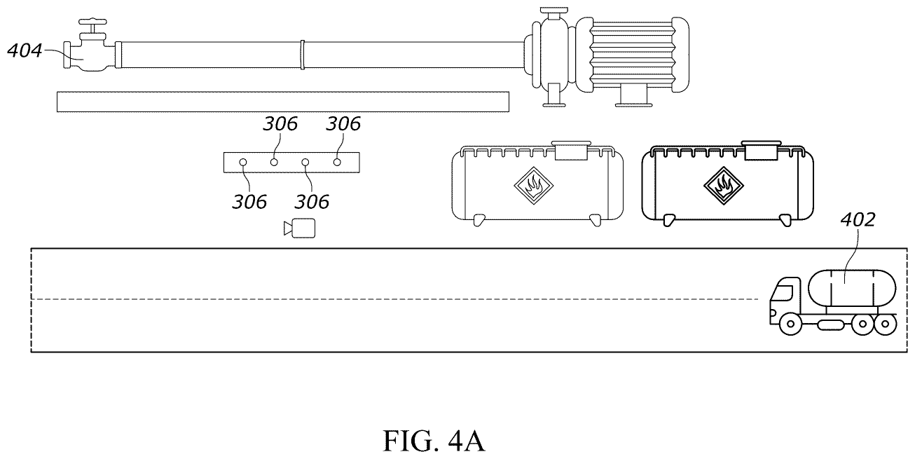

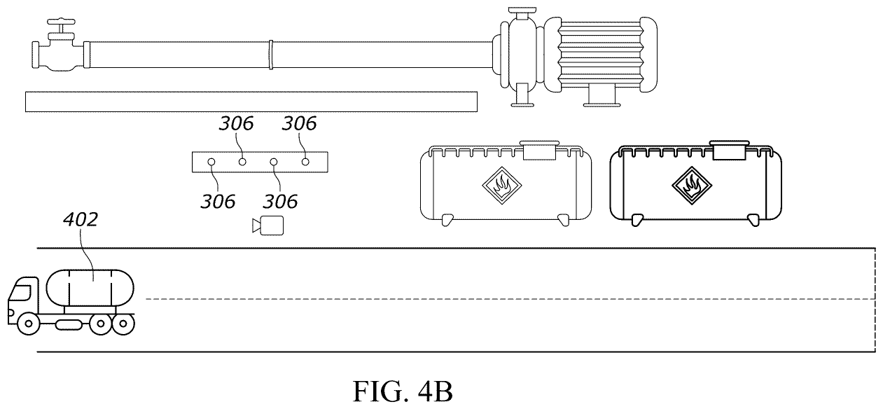

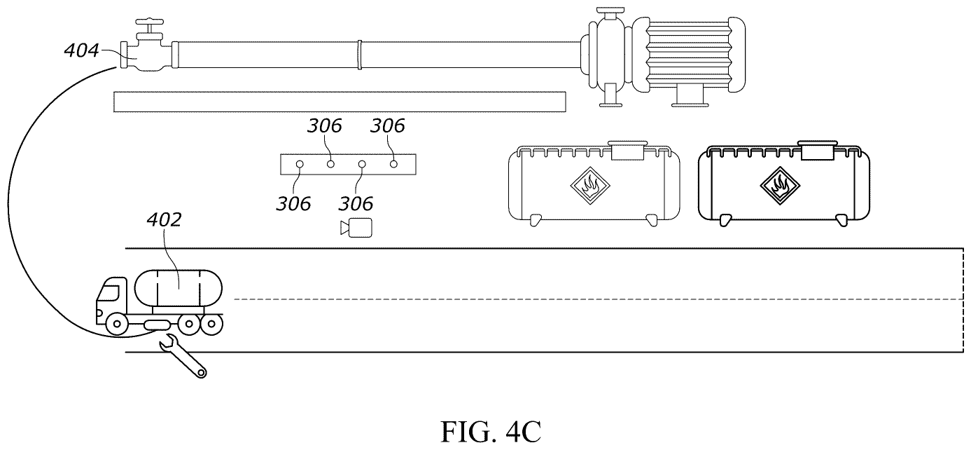

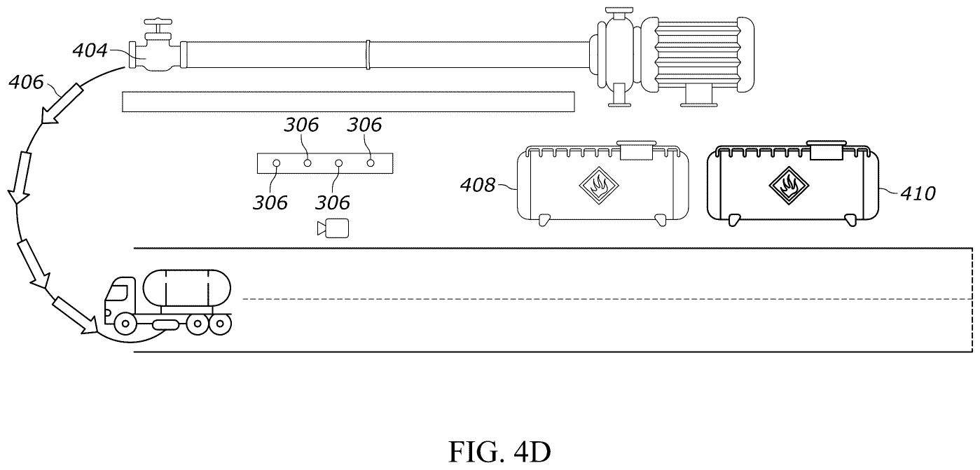

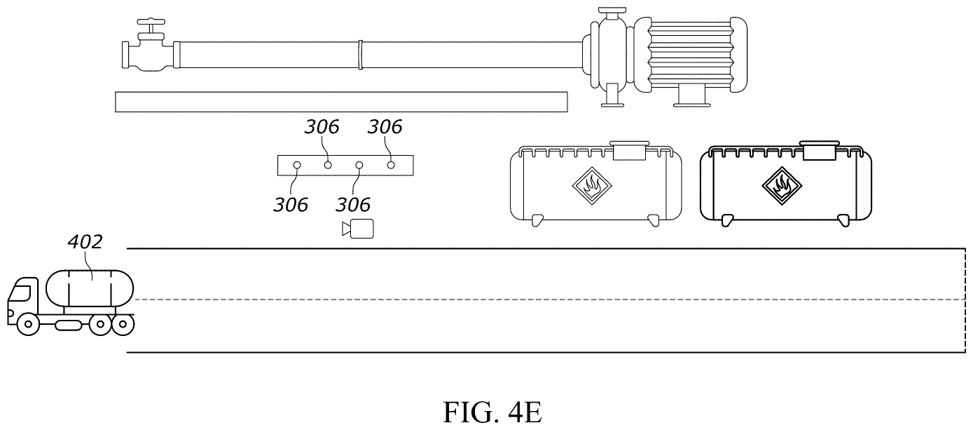

To give context to embodiments disclosed herein, it may help to describe what may occur during a standard refueling event, for example at a refueling station or refueling depot at an airport. Typical refueling operation at the fueling depot occurs as follows, referring to FIGS. 4A-4E as an example. First, an empty scene active with peripheral sounds occurs. As shown in FIG. 4A, a fuel truck 402 slowly pulls in and enters the scene, with its engine on. Thereafter, the fuel truck stops (for example, at a designated refueling stopping point) and turns off the engine (FIG. 4B), and begins setup for the refueling operation which involves some moving around, gaps, metal clanking, and other extraneous noise, etc. Most notably in this setup period is the sound of the ratcheting mechanism used to ground the fuel truck, as shown in FIG. 4C. This is one key indicator that a refueling operation is close to occurring. After setup is complete, the operator turns on the fuel pump 404 and several high amplitude noises are made during this transient state but very quickly reaches a steady state of a constant fuel pump running, as shown by arrows 406 in FIG. 4D. During this time, fuel flows from a fuel tank 408 (e.g., JET-A fuel) or 410 (e.g., AvGas) into the tank of the fuel truck 402. Once the fuel truck 402 is filled, the fuel pump 404 shuts off immediately. Following this a breakdown process begins, which is essentially the reverse of the setup procedure. In performing the breakdown of the setup, the ratcheting mechanism which is used for grounding the fuel truck is heard and put in its original resting place. Breakdown of the equipment is completed, and the fuel truck 402 is ready to depart. Then, the operator starts the fuel truck 402 and idles for some period as they complete paperwork in the fuel truck and prepare to leave. Shortly after the beginning of the idling of the truck, the truck 402 departs and the refueling operation is complete (FIG. 4E).

According to embodiments, an audio capturing array such as one or more microphones 306 is installed at the fueling station at or near the location where the fuel truck 402 refuels. This allows for the capturing of audio data at each of the steps of the refueling operation. Optionally, an image capturing device 302, such as a camera, is installed having a field of view of the entire refueling operation.

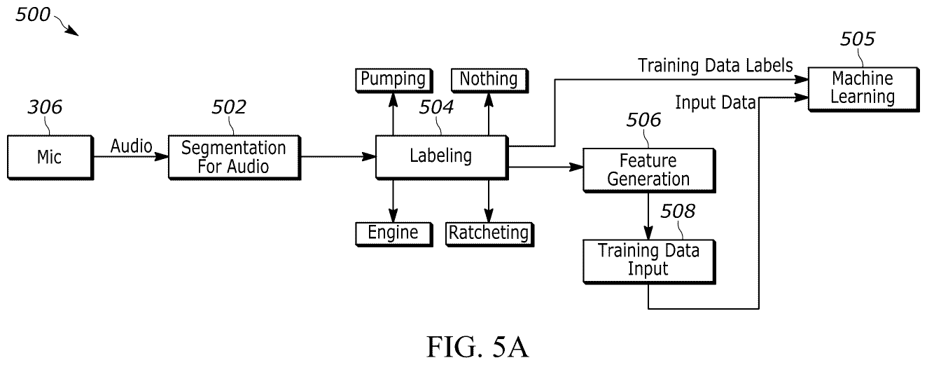

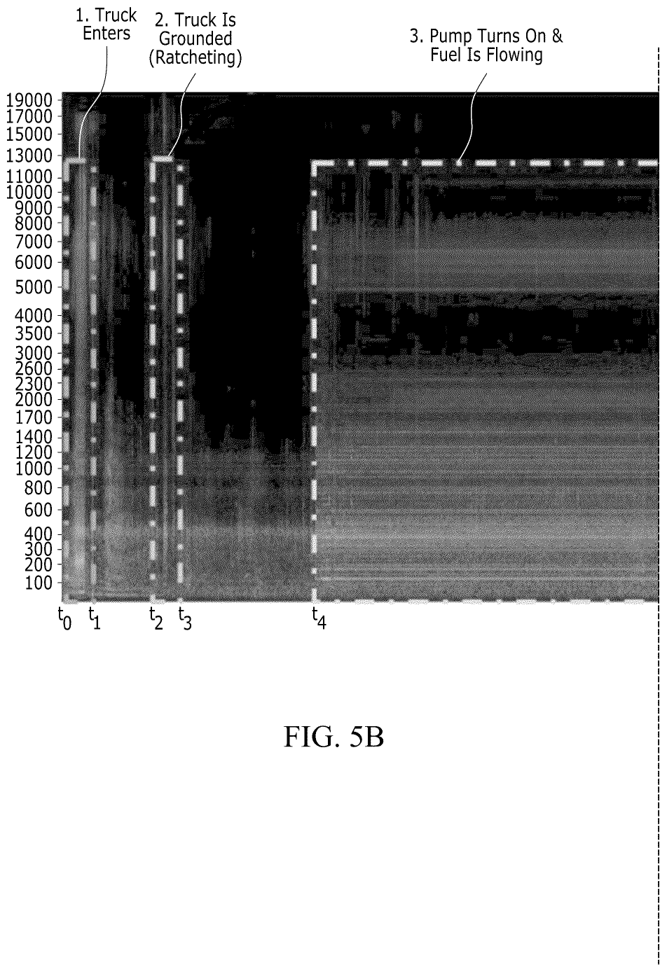

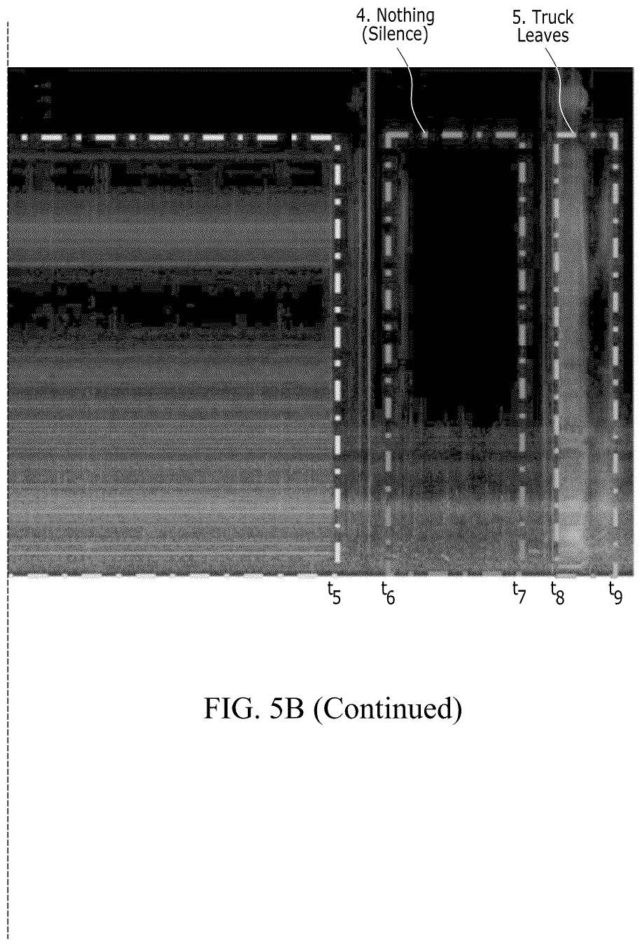

FIG. 5A illustrates a block diagram showing an overall schematic of a system 500 for determining stages of a refueling operation, according to an embodiment. A microphone 306 or audio capturing array is installed at or near a fueling station, as is shown in FIG. 4. The microphone 306 generates audio data associated with various events taking place at the fueling station, such as the truck entering the scene, the truck being grounded or ratcheted to the pump, the fuel pump being turned on, the truck idling and/or leaving, and other events as described herein. A segmentation model 502 is executed on the audio data for segmenting the audio into segments, with each segment associated with a respective one of these audio events. The model also labels each segment, generally shown at 504. Each segment is labeled as one of the refueling events. Here, labels such as pumping, engine (e.g., idling), ratcheting, and nothing can be provided, as well as other events.

FIG. 5B illustrates an example spectrogram with identified relevant acoustic stages that occur during a refueling operation, as identified by the model. For example, between t₀ and t₁, the noise detected by the microphone is segmented and labeled as being associated with noise of the fuel truck entering the scene. Between times t₂ and t₃, the noise detected by the microphone is segmented and labeled as being associated with noise of the truck being grounded or ratcheted, connected to the fuel pump. Between times t₄ and t₅, the noise detected by the microphone is segmented and labeled as being associated with noise of the fuel flowing from the pump into the tanker truck. Between times t₆ and t₇, no identifiable noise associated with a refueling operation is detected, and so such time can be segmented and labeled as nothing (e.g., silence). Between times t₈ and t₉, the noise detected by the microphone is segmented and labeled as being associated with noise of the tanker truck leaving, such as the engine turning on and moving away from the microphone (e.g., driving away).

The model 502 used for segmenting, labeling, and/or classifying such audio data can be one or more of the models described herein. For example, the model may be a recurrent neural network (RNN), convolutional neural network (CNN), deep neural network (DNN), transformer model (e.g., BERT, GPT, etc.), hidden Markov model (HMM), and the like.

Alternatively, the audio data can initially be segmented and labeled manually (e.g., by human) for training the model to do so automatically once trained. As such, a human annotator can manually listen to the audio, segment the audio and label each segment as being associated with one of the particular stages or events of a refueling operation. The labeling of the data can be fed as training data into the machine learning model 505, which can be one or more of the models described herein. The machine learning model 505 can be trained to segment and label the audio data with the various stages of the refueling operation, similar to that shown in FIG. 5B.

In embodiments, feature generation (shown generally at 506) can be implemented as part of the system. This refers to the process of extracting relevant information or characteristics (features) from the audio data that can be used as input for the machine learning algorithms. These extracted features are used for training the models to perform various tasks such as classification, segmentation, sound event detection, or other audio-related tasks described herein. Feature generation can involve converting the raw or preprocessed audio signals into a set of numeric features that capture different aspects of the audio content. The techniques used for feature generation can include spectrogram generation, which involves transforming the audio signal into a spectrogram which represents the frequency content of the signal over time. This can involve performing a Short-Time Fourier Transform (STFT) or other time-frequency analysis to create a 2D matrix of intensity values corresponding to different frequencies at each time frame. The feature generation can also include Mel-Frequency Cepstral Coefficients (MFCCs) (e.g., FIG. 5B) which involves taking the log of the power spectrum of the audio signal at specific Mel-spaced frequency bands. In either embodiment, once these features are extracted, they can form a numerical representation of the audio signal, enabling machine learning algorithms to learn patterns and relationships within the data for specific tasks. The result of the feature generation is training data input 508, which can be used to train the machine learning model 502 to perform the segmentation, labeling, feature generation, and the like.

As shown, in general, an acoustic data stream is taken from the multi-channel microphone array, segmented, labeled, and then used as input to an acoustic machine learning classifier. To generate the acoustic data, a data driven approach is used to create a model robust to various peripheral sounds that may occur in the scene. Examples may include high amplitude noise from aircraft actively taking off and taxiing nearby refueling depot, other airport operations, other vehicles, humans operating nearby, etc. To make this system agnostic to these variables, several refueling operations can be used and sampled with a fixed window length for each class and labeled respectively, thereby creating thousands of training samples for each class. Due to the nature of the short duration of certain classes, labeled data can be shuffled and balanced for training. This system is resilient to the chaotic environment it is deployed in order to avoid inconsistent and unreliable flags of refueling events.

While not shown in the schematic of FIG. 5A, it should be understood that video can be used to confirm the audio-based events. For example, as explained above, a camera or other image capturing device can be placed at the fueling station. A video feed or stream can be annotated and labeled by a human annotator, whereby the annotator identifies the times of the videos in the various refueling operations (e.g., truck entering scene, truck being grounded/ratcheted, fueling beginning, fueling stopping, truck leaving) take place. The video can be synchronized with the audio, such that the annotator can both see and hear the events taking place at the fueling station. The use of video is optional, but gives the annotator more confidence in the labeling of the refueling events. This allows the audio data to be used to train the machine learning model, such that the machine learning model can be later executed on only audio (not video) data, in the event a camera is not available or in use at the fueling station. Moreover, once trained, the machine learning model can corroborate the determination made based on audio data that a certain fueling stage is taking place.

The machine learning model can also be trained to identify the refueling operation in which fuel is being delivered based upon the other identified refueling operations. For example, the model can be trained to understand that immediately subsequent the sound of the truck being grounded or ratcheted, the fuel pump will be turned on shortly. This can ready the model and prepare it for a sound event that will indicate fueling. Also, noise such as ratcheting and connecting and disconnecting the tanker truck from the pump occur before and after the fueling operation, and therefore the model can be configured to look for sound between those ratcheting noises. In other words, the context of the scene outside of the time of fueling can be processed by the machine learning model to indicate the fueling is taking place.

Once trained, the machine learning models described herein can also be used for determining the amount of fuel being delivered to the tanker truck. For example, in an embodiment, the machine learning model identifies and labels the time period in which the truck is fueling (e.g., fuel being delivered), such as shown in FIG. 4D and between times t₄ and t₅ of FIG. 5B. This time amount can be multiplied by the known fuel flow rate, which is the rate of fuel that flows from the fuel tanks 408 or 410 to the fuel truck 402 via pump 404. This fuel flow rate can be a known constant, such as known by the fueling station facilitator (e.g., airport). Alternatively, the fuel flow rate can be varied, and the machine learning model can be trained to determine the fuel flow rate based on the sound. In such an embodiment, training data representing a fuel flow rate and the sound of the fueling operation can be fed to the machine learning model so that the model can determine or estimate a fuel flow rate based on the emitted sound from the pump or fuel lines, for example.

Once the fuel flow rate is determined, the model can simply multiple this rate by the length of time that the fueling operation is going (e.g., between times t₄ and t₅ of FIG. 5B) as determined by the model. This can yield an estimated fuel delivery quantity. This quantity can be compared to the logged amount of fuel that was logged by the fueling personnel in order to confirm an accurate amount of fuel being logged and charged.

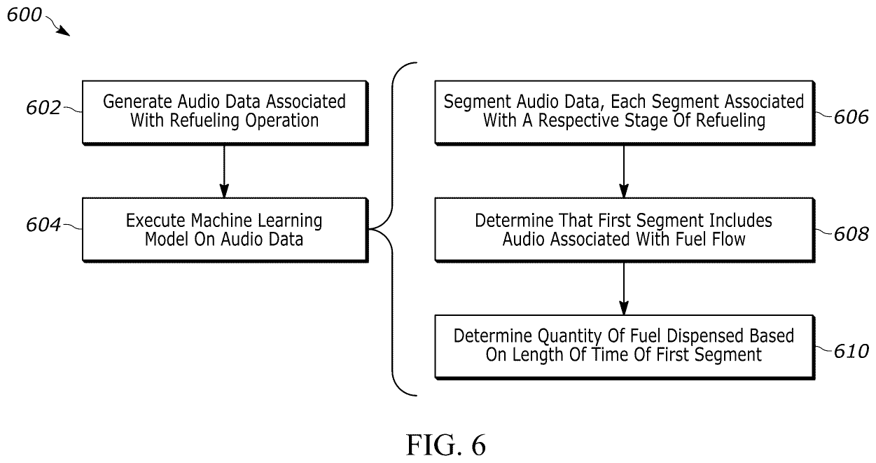

FIG. 6 illustrates a flow chart of an exemplary method 600 of determining a quantity of fuel dispensed at a fueling station based utilizing an audio-based machine learning model. The method 600 can be performed by any of the systems described herein, such as computing system 202, and can be trained according to the teachings described herein.

At 602, audio data is generated, for example by one or more microphone or microphone array as described herein. The microphone(s) can be positioned at or near a fueling station so as to capture sounds emitted by fuel trucks that enter the fueling station, as well as personnel that work to hook up, connect, disconnect, etc. the truck. This audio data can be raw audio data, or preprocessed (e.g., denoise or the like).

At 604, a machine learning (ML) model is executed on the audio data. The ML model can be one or more of the types described herein, such as a CNN, DNN or the like. The ML model is trained so as to recognize various sounds occurring at the fueling station, label them, and act accordingly. For example, steps 606-610 can be performed by execution of the ML model.

At 606, the ML model segments the audio data. The ML model may be trained to recognize certain sound as stages of a refueling operation, such as a truck entering the scene (e.g., by the sound of its engine), an operator ratcheting or connecting the truck to the fuel line, the pump operating to deliver fuel to the truck, the operator disconnecting the truck from the fuel line, the truck idling in the scene, and the truck driving away. As such, the ML model can segment the audio data into segments. Each segment can include audio data of a respective stage of refueling.

At 608, the ML model determines that one of these segments (e.g., a first segment) includes audio or audio data associated with a fuel flow stage of the refueling operation in which fuel is dispensed. This can be based upon the sound that represents the fuel pump being operational, and/or fuel being transmitted through the pump and/or fuel lines that connect to the truck. Identification of this time period can indicate the moments in which fuel is being delivered.

At 610, the ML model determines the length of time of that segment associated with the fuel flow stage. For example, this can be a number of minutes and seconds. Based on the amount of time that fuel is flowing into the truck, the ML model can estimate or determine an amount or quantity of fuel that has been dispensed into the truck. Thus, when a human operator abides by a honor system of logging how much fuel is dispensed, the ML model can confirm that amount based on its determined estimate of fuel dispensed. For example, the ML model can be provided with a logged amount of fuel dispensed (e.g., logged by a human fuel truck operator). The ML model can compare this logged amount of fuel dispensed with the quantity of fuel dispensed as determined by the ML model. The ML model can determine a discrepancy between these two amounts and react accordingly. For example, if the difference between the ML model's determined quantity of fuel dispensed and the logged amount of fuel dispensed exceeds a threshold, the ML model can cause an alert to be issued. The threshold can be a percentage (e.g., the determined quantity of fuel dispensed exceeding the logged fuel dispensed by 5%, 10%, or more). Alternatively, the threshold can be an amount, such as a number of gallons or liters of fuel discrepancy. The output alert can be a visual or audio warning to an operator or facilitator of the system that audits the amount of fuel dispensed from the fueling station.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of determining a quantity of fuel dispensed at a fueling station based on audio, the method comprising:
generating audio data from one or more microphones, wherein the audio data is associated with stages of a refueling operation at a fueling station; and
executing a machine learning model on the audio data, wherein the machine learning model is configured to, upon execution:
segment the audio data into segments, wherein each segment is associated with a respective one of the stages of the refueling operation;
determine that a first segment of the segments includes audio associated with a fuel flow stage of the refueling operation in which fuel is dispensed;
determine a length of time of the first segment; and
determine a quantity of fuel dispensed based on the length of time of the first segment.

2. The method of claim 1, wherein the machine learning model is further configured to, upon execution:
determine that a second segment of the segments includes audio associated with a fuel truck approaching the fueling station;
determine that a third segment of the segments includes audio associated with a grounding of the fuel truck; and
determine that a fourth segment of the segments includes audio associated with the fuel truck leaving the fueling station.

3. The method of claim 2, wherein the machine learning model is further configured to, upon execution,
determine that the first segment of the segments includes audio associated with the fuel flow stage based upon (1) the determination that the second segment of the segments includes audio associated with a fuel truck approaching the fueling station, and (2) the determination that third segment of the segments includes audio associated with a grounding of the fuel truck.

4. The method of claim 1, wherein the machine learning model is further configured to, upon execution:
compare the quantity of fuel dispensed to a logged amount of fuel dispensed; and
output an alert if a difference between the quantity of fuel dispensed and a logged amount of fuel dispensed exceeds a threshold.

5. The method of claim 1, further comprising:
receiving training audio data, wherein the training audio data is associated with the stages of refueling operations at a fueling station;
receiving annotations on the training audio data, wherein the annotations include labeling of audio events in the audio data corresponding to the stages of refueling operations; and
training the machine learning model based on the training audio data and the annotations to determine audio events associated with the fuel flow stage of the refueling operation in which fuel is dispensed.

6. The method of claim 1, further comprising:
generating image data from one or more cameras, wherein the image data is associated with the refueling operation at the fueling station; and
executing the machine learning model on the image data, wherein the machine learning model is configured to, upon execution:
identify a fuel truck in the image data, and
verify that the first segment of the segments includes audio associated with a fuel flow stage of the refueling operation based on the fuel truck identified in the image data.

7. The method of claim 1, wherein the machine learning model is configured to, upon execution:
determine a type of fuel dispensed based on the audio data.

8. A system for training a machine learning model to determine a quantity of fuel dispensed at a fueling station based on audio, the system comprising:
a microphone installed at a fueling station, wherein the microphone is configured to generate audio data associated with stages of a refueling operation occurring at the fueling station;
a processor; and
memory having instructions that, when executed by the processor, cause the processor to:
receive annotations associated with the audio data from an annotator, wherein the annotations include a segmentation of the audio data with labels, wherein each label is associated with a respective stage of the refueling operation;
provide, as training data, the segmentations of the audio data and the labels to a machine learning model;
train the machine learning model to identify the stages of the refueling operation based on the training data; and
output a trained machine learning model configured to identify the stages of the refueling operation based on audio.

9. The system of claim 8, wherein one of the stages of the refueling operation includes fuel flow, and the training includes training the machine learning model to identify fuel flow based on the training data.

10. The system of claim 9, wherein the memory, when executed by the processor, causes the processor to:
train the machine learning model to determine the fuel flow to be during a first time period, and determine a quantity of fuel flow based on a length of the first time period.

11. The system of claim 8, wherein the trained machine learning model is configured to, upon execution:
segment the audio data into segments, wherein each segment is associated with a respective one of the stages of the refueling operation;
determine that a first segment of the segments includes audio associated with a fuel flow stage of the refueling operation in which fuel is dispensed;
determine a length of time of the first segment; and
determine a quantity of fuel dispensed based on the length of time of the first segment.

12. The system of claim 11, wherein the trained machine learning model is configured to, upon execution,
determine that the first segment of the segments includes audio associated with the fuel flow stage based upon (1) the determination that a second segment of the segments includes audio associated with a fuel truck approaching the fueling station, and (2) the determination that third segment of the segments includes audio associated with a grounding of the fuel truck.

13. The system of claim 8, wherein the trained machine learning model is configured to, upon execution,
compare the quantity of fuel dispensed to a logged amount of fuel dispensed; and
output an alert if a difference between the quantity of fuel dispensed and a logged amount of fuel dispensed exceeds a threshold.

14. A system for determining a quantity of fuel dispensed at a fueling station based on audio, the system comprising:
a microphone configured to generate audio data associated with stages of a refueling operation at a fueling station; and
a processor programmed to execute a machine learning model on the audio data, wherein the machine learning model is configured to, upon execution:
segment the audio data into segments, wherein each segment is associated with a respective one of the stages of the refueling operation;
determine that a first segment of the segments includes audio associated with a fuel flow stage of the refueling operation in which fuel is dispensed;
determine a length of time of the first segment; and
determine a quantity of fuel dispensed based on the length of time of the first segment.

15. The system of claim 14, wherein the machine learning model is further configured to, upon execution:
determine that a second segment of the segments includes audio associated with a fuel truck approaching the fueling station;
determine that a third segment of the segments includes audio associated with a grounding of the fuel truck; and
determine that a fourth segment of the segments includes audio associated with the fuel truck leaving the fueling station.

16. The system of claim 15, wherein the machine learning model is further configured to, upon execution,
determine that the first segment of the segments includes audio associated with the fuel flow stage based upon (1) the determination that the second segment of the segments includes audio associated with a fuel truck approaching the fueling station, and (2) the determination that third segment of the segments includes audio associated with a grounding of the fuel truck.

17. The system of claim 14, wherein the machine learning model is further configured to, upon execution:
compare the quantity of fuel dispensed to a logged amount of fuel dispensed; and
output an alert if a difference between the quantity of fuel dispensed and a logged amount of fuel dispensed exceeds a threshold.

18. The system of claim 14, wherein the processor is further programmed to:
receive training audio data, wherein the training audio data is associated with the stages of refueling operations at a fueling station;
receive annotations on the training audio data, wherein the annotations include labeling of audio events in the audio data corresponding to the stages of refueling operations; and
train the machine learning model based on the training audio data and the annotations to determine audio events associated with the fuel flow stage of the refueling operation in which fuel is dispensed.

19. The system of claim 14, wherein the processor is further programmed to:
generate image data from one or more cameras, wherein the image data is associated with the refueling operation at the fueling station; and
execute the machine learning model on the image data, wherein the machine learning model is configured to, upon execution:
identify a fuel truck in the image data, and
verify that the first segment of the segments includes audio associated with a fuel flow stage of the refueling operation based on the fuel truck identified in the image data.

20. The system of claim 14, wherein the machine learning model is configured to, upon execution:
determine a type of fuel dispensed based on the audio data.
